(19) United States
(12) Patent Application Publication
(10) Pub. No.: US 2025/0199222 A1
(43) Pub. Date: Jun. 19, 2025

(54) METHOD OF GENERATING POLARIZATION GRATING USING PLANAR SOLITON AND POLARIZATION GRATING GENERATED BY SAME

(71) Applicant: FOUNDATION OF SOONGSIL UNIVERSITY-INDUSTRY COOPERATION, Seoul (KR)

(72) Inventors: Hyun Hee CHOI, Seoul (KR); Yong Gi SIM, Seoul (KR)

(21) Appl. No.: 19/058,969

(22) Filed: Feb. 20, 2025

Related U.S. Application Data
(63) Continuation of application No. PCT/KR2022/016237, filed on Oct. 24, 2022.

(30) Foreign Application Priority Data
Aug. 25, 2022 (KR) 10-2022-0106660

(51) Int. Cl. G02B 5/30

(52) U.S. Cl. CPC G02B 5/3016

(57) ABSTRACT

A method of generating a polarization grating includes: generating a disclination pair having topological charges of k=±½ and k=−½ in a liquid crystal; trapping one first topological charge of the disclination pair using optical tweezers; and generating a planar soliton by moving the trapped topological charge, wherein desired diffracted light is obtained by the planar soliton.

### CROSS-REFERENCE TO RELATED APPLICATION

This application is a continuation of pending PCT International Application No. PCT/KR2022/016237, which was filed on Oct. 24, 2022, and which claims priority to Korean Patent Application No. 10-2022-0106660 which was filed in the Korean Intellectual Property Office on Aug. 25, 2022. The disclosures of which are hereby incorporated by reference in their entireties.

### BACKGROUND

### (a) Technical Field

The present invention relates to a method of generating a polarization grating using a planar soliton and a polarization grating generated by the same.

### (b) Background Art

A polarization grating for optical deflection and polarization modulation is a diffraction grating with a fixed or variable period.

In general, polarization gratings record light interference patterns using optical polymers or azo-based liquid crystal polymers that exhibit photoisomerization reaction.

FIG. 1 shows a process of generating a polarization grating by recording polarization interference of recording light of Right-handed Circular Polarization (RCP) and Left-handed Circular Polarization (LCP).

To generate a polarization grating, interference light is generated using two recording lights of RCP and LCP. It can be seen that polarization interference light, in which linear polarization rotates, is generated due to the interference of recording lights. By aligning azo dye molecules perpendicular to the polarization interference light generated in this case, polarization interference is recorded, and it can function as a polarization grating.

That is, when polarization interference by two or more recording lights is recorded on a material that responds to polarization, molecules are aligned perpendicular or parallel to the polarization depending on the material, thereby a polarization grating is generated.

FIG. 2 is a view showing a process of generating a polarization grating in the related art.

In FIG. 2, a of FIG. 2 shows the most common method of generating a polarization grating, in which right-handed circular polarization and left-handed circular polarization are introduced to a sample to record polarization interference of the two recording lights on the sample.

In the case of using the method of a of FIG. 2, a grating is formed extensively in the area where the polarization interference of the recording lights is introduced. However, when the pattern of desired polarization diffracted light is complex, it is not easy to generate a corresponding polarization grating.

In FIG. 2, b of FIG. 2 is a method of generating polarization interference using a Spatial Light Modulator (SLM) and recording it on a sample. Since a periodic change in polarization is generated by a spatial light modulator and is recorded, a polarization grating with a relatively wide spacing is formed due to the resolution limitation of the spatial light modulator.

In FIG. 2, c of FIG. 2 is a method of recording a direct laser beam, in which polarization is changed by a polarization rotator and is recorded point by point in synchronization with the stage, so the recording speed is very slow, and the resolution is very poor because the laser spot size cannot be smaller than the laser wavelength.

In FIG. 2, d of FIG. 2 is a method using a polarization mask, in which since a mask creation process is required, a polarization grating cannot be immediately formed and it is required to generate an expensive mask.

### STATEMENT REGARDING PRIOR DISCLOSURES BY THE INVENTOR OR A JOINT INVENTOR

At least one inventor or joint inventor of the present disclosure has made related disclosures in Optical materials Express on Jan. 1, 2022.

### SUMMARY OF THE DISCLOSURE

In order to solve the problems of the related art described above, the present invention is to propose a method of generating a polarization grating using planar solitons to increase resolution and obtain a desired diffraction pattern, and a polarization grating formed by the method.

In order to achieve the object described above, according to an embodiment of the present invention, there is provided a method of generating a polarization grating that includes: generating a disclination pair having topological charges of k=±½ and k=−½ in a liquid crystal; trapping one first topological charge of the disclination pair using optical tweezers; and generating a planar soliton by moving the trapped topological charge, wherein desired diffracted light is obtained by the planar soliton.

The generating of a disclination pair may include severing a n-wall existing in the liquid crystal using the optical tweezers or severing a predetermined point of the planar soliton using the optical tweezers.

The generating of a disclination pair may include generating the disclination pair by optical-aligning a local area to be perpendicular to liquid crystal alignment using the optical tweezers and then generating a multi-domain of liquid crystal alignment due to spontaneous symmetry-breaking at the boundary between the optical-aligned area and the liquid crystal alignment through isotropic-nematic phase transition.

The generating of a planar soliton may include generating a closed-loop planar soliton or a planar soliton grating with an irregular cycle or shape by continuously moving the trapped topological charge in an unlimited direction.

When the first topological charge and a second topological charge with a different polarity are moved in opposite directions to each other, liquid crystal alignment may have the same shape.

The generating of a planar soliton grating may include: moving the trapped first topological charge in a first direction; generating a disclination having a topological charge of k=±1 or k=−1 using intercommutation of a planar soliton formed by movement of the first topological charge, wherein when the disclination having a topological charge of k=±1 or k=−1 is generated, the trapped first topological charge is changed into a second topological charge with a different polarity; and generating a planar soliton grating by moving the second topological charge in a second direction different from the first direction.

The generating of a planar soliton grating may further include repeatedly performing movement of the first topological charge in the first direction and movement of the second topological charge in the second direction.

When right-handed circular polarization is incident on one line of the planar soliton, polarization of diffracted light may be converted into left-handed circular polarization, and when incident light is left-handed circular polarization, polarization of diffracted light may be converted into right-handed circular polarization.

When straight polarization is incident on one line of the planar soliton, polarization of diffracted light may become left-handed circular polarization and right-handed circular polarization at orders having different signs, respectively.

Polarization of diffracted light appearing at a + order and a − order may be determined in accordance with liquid crystal alignment of the planar soliton.

The planar soliton grating may include a plurality of first planar solitons having first liquid crystal alignment and spaced at predetermined gap, and a second planar soliton having liquid crystal alignment different from the first liquid crystal alignment and disposed between the plurality of first planar solitons.

When polarization of incident light is circular polarization, constructive interference of diffracted lights passing through a plurality of first planar solitons spaced by d from each other may be defined as a case in which a first path difference of the diffracted lights is an integer multiple of a wavelength of light.

When polarization of incident light is linear polarization and a gap between the plurality of first planar solitons and the second planar soliton is d/2, a second path difference of diffracted light passing through the first planar solitons and diffracted light passing through the second planar soliton may be defined as a half of the first path difference.

When a gap between one of the plurality of first planar solitons and the second planar soliton is d/k (where, k is a positive rational number), diffracted light passing through the first planar solitons and diffracted light passing through the second planar soliton may interfere with each other to represent linear polarization in which an polarization axis may be rotated by 180°*m/k with respect to a polarization axis of 0-th light in accordance with a diffraction order m.

The planar soliton grating may include a plurality of planar solitons having different liquid crystal alignment or a plurality of closed-loop planar solitons having one or more polygonal shapes.

According to another aspect of the present invention, a polarization grating generated by the method described above is provided.

According to the present invention, since a polarization grating is generated by changing liquid crystal alignment through a method of trapping and physically moving a disclination rather than a method of recording the polarization of interference light using an optical method, there is an advantage in that it is possible to provide a polarization grating with high degree of freedom and high resolution.

### BRIEF DESCRIPTION OF THE DRAWINGS

FIG. 1 shows a process of generating a polarization grating using recording lights with right-handed circular polarization and left-handed circular polarization, which is generally performed.

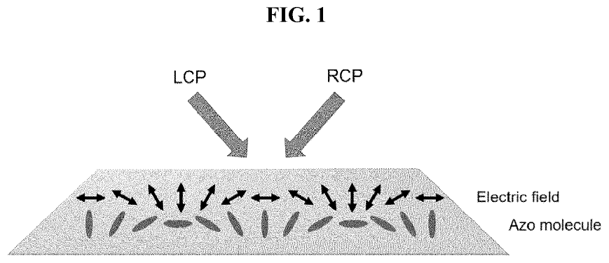

FIG. 2 is a view showing methods of generating a polarization grating in the related art.

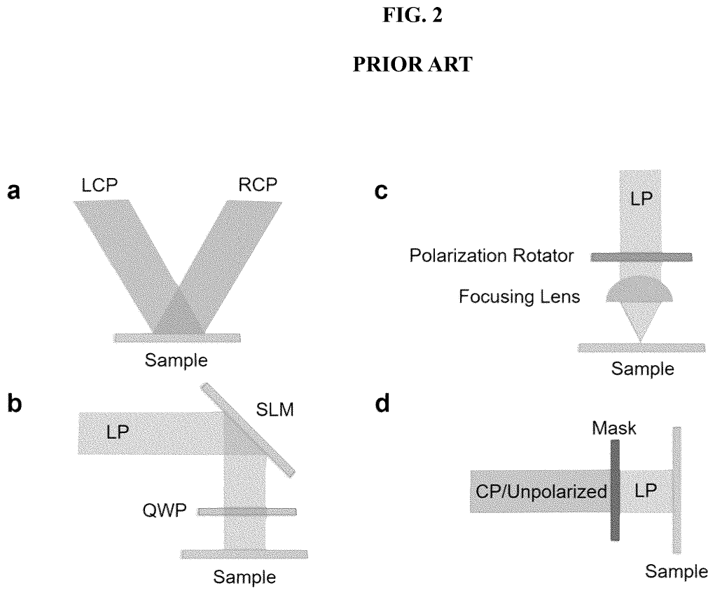

FIG. 3 is a diagram showing the alignment (director field) of a disclination pair of k=+½ generated within a liquid crystal and a process of generating a planar soliton using optical tweezers.

FIG. 4 is a diagram showing the configuration for trapping a topological charge using optical tweezers.

FIG. 5 shows a process of generating a planar soliton according to the embodiment by trapping one topological charge of a disclination pair of k=±½.

FIG. 6 is a diagram exemplarily showing cases where a disclination of k=±1 or k=−1 or a closed-loop planar soliton is generated by intercommutation of planar solitons according to the embodiment.

FIG. 7 shows microscopic images showing a line of generated planar soliton, an alignment diagram thereof, and a corresponding diffraction pattern.

FIG. 8 shows microscopic images of a one-dimensional soliton grating of planar solitons formed in an S-shaped pattern, an alignment diagram thereof, and a corresponding diffraction pattern.

FIG. 9 shows microscopic images of planar solitons formed by various movement paths of topological charges, an alignment diagram thereof, and corresponding diffraction patterns.

FIG. 10 is a diagram showing the results of generating planar soliton gratings in various ways in a nematic liquid crystal according to the embodiment and their diffraction patterns.

### DETAILED DESCRIPTION

The present invention may be modified in various ways and implemented by various exemplary embodiments, so that specific exemplary embodiments are shown in the drawings and will be described in detail herein. However, it is to be understood that the present invention is not limited to the specific exemplary embodiments, but includes all modifications, equivalents, and substitutions included in the spirit and the scope of the present invention.

The terms used in this specification are used only in order to describe specific exemplary embodiments rather than limiting the present invention. Singular forms are intended to include plural forms unless the context clearly indicates otherwise. It will be further understood that the term “comprises” or “have” used herein specifies the presence of stated features, numerals, steps, operations, components, parts, or a combination thereof, but do not preclude the presence or addition of one or more other features, numerals, steps, operations, components, parts, or a combination thereof.

Further, the components of embodiments described with reference to the drawings are not limited only to corresponding embodiments and may be implemented to be included in other embodiments within the range of the technical spirit of the present invention, and it is also apparent that even though separate explanations are omitted, a plurality of embodiments may be integrated and re-implemented as a single embodiment.

Further, in description of the accompanying drawing, same components are given relevant or the same reference numerals regardless of the figure numbers and overlapping descriptions thereof will be omitted. In describing the present invention, if it is determined that the detailed description of well-known technologies may unnecessarily obscure the gist of the present invention, it will be omitted.

The present invention may be modified in various ways and implemented by various exemplary embodiments, so that specific exemplary embodiments are shown in the drawings and will be described in detail herein. However, it is to be understood that the present invention is not limited to the specific exemplary embodiments, but includes all modifications, equivalents, and substitutions included in the spirit and the scope of the present invention.

The terms used in this specification are used only in order to describe specific exemplary embodiments rather than limiting the present invention. Singular forms are intended to include plural forms unless the context clearly indicates otherwise. It will be further understood that the term “comprises” or “have” used herein specifies the presence of stated features, numerals, steps, operations, components, parts, or a combination thereof, but do not preclude the presence or addition of one or more other features, numerals, steps, operations, components, parts, or a combination thereof.

Further, the components of embodiments described with reference to the drawings are not limited only to corresponding embodiments and may be implemented to be included in other embodiments within the range of the technical spirit of the present invention, and it is also apparent that even though separate explanations are omitted, a plurality of embodiments may be integrated and re-implemented as a single embodiment.

Further, in description of the accompanying drawing, same components are given relevant or the same reference numerals regardless of the figure numbers and overlapping descriptions thereof will be omitted. In describing the present invention, if it is determined that the detailed description of well-known technologies may unnecessarily obscure the gist of the present invention, it will be omitted.

In the embodiment, instead of recording polarization interference using an optical method, a polarization grating is generated by trapping disclinations and physically moving them to change the alignment of the liquid crystal.

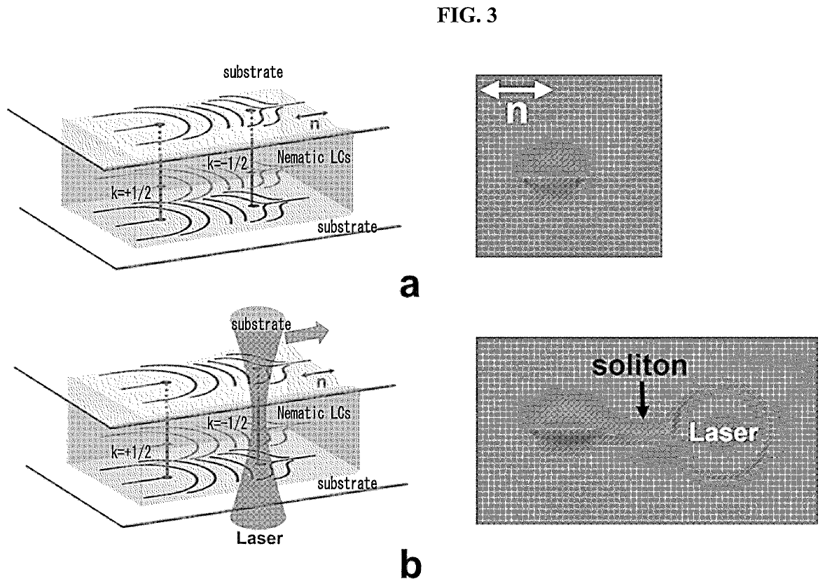

FIG. 3 is a diagram showing the alignment (director field) of a disclination pair of k=±½ generated in a liquid crystal and a process of generating a planar soliton using optical tweezers.

Referring to a of FIG. 3, a disclination pair having topological charges of k=±½ and k=−½ is generated in the liquid crystal. The direction of arrow n indicates the initial alignment direction of the liquid crystal due to substrate rubbing.

According to this embodiment, a plurality of disclination pairs of k=±½ may be formed. The generation of disclination pairs is possible in the boundary region where the alignment symmetry of a nematic liquid crystal cell doped with azo dye is broken due to photoisomerization and spontaneous symmetry-breaking I-N (isotropic-nematic) phase transition.

In more detail, according to this embodiment, after optically aligning a local region perpendicularly to liquid crystal alignment using optical tweezers and then inducing an isotropic-nematic phase transition, multi-domain of liquid crystal alignment is generated at the boundary between an optically aligned region and the liquid crystal alignment due to spontaneous symmetry-breaking, whereby disclination pairs are generated.

As shown in b of FIG. 3, one of disclination pair having topological charges of k=±½ is trapped using optical tweezers, and the trapped topological charge is moved in a predetermined direction using the optical tweezers to generate a planar soliton.

A process of generating a disclination and a planar soliton according to this embodiment is described as follows.

To reduce anchoring energy of a liquid crystal cell substrate, instead of using a commonly used polyimide alignment layer, two types of substrates were used, in which the first was a bare glass substrate and the second was an epoxy-coated substrate. When a bare glass substrate or an epoxy-coated substrate is used, the anchoring energy (azimuthal anchoring energy) becomes lower than that of a substrate with an alignment layer. To coat a substrate with epoxy, epoxy is mixed with acetone and applied onto a glass substrate, and then it is cured with UV.

By reducing the anchoring energy of the substrate, topological charges can be trapped and moved using optical tweezers.

By rubbing the substrate of the liquid crystal cell in one direction, the liquid crystal alignment is arranged parallel to the substrate in one direction (indicated as director n), and the planar soliton generation process is performed in this state.

Due to the anchoring conditions that align the liquid crystal parallel to the substrate, topological charges of k=±½ and k=−½ is formed as a disclination in a line perpendicular to the bare glass substrate, as shown in FIG. 3A.

Disperse Red 1 (DR 1) dye is a pseudo-stilbene azo chromophore, which, in its trans-state, absorbs light polarized in a direction parallel to the transition dipole moment of DR 1 molecule, exciting it to a cis-isomeric form. It then releases heat or absorbs light of the same wavelength to revert to a trans-isomeric form.

The trans-cis photoisomerization phenomenon occurs repeatedly until the transition dipole moment of the DR 1 molecule is aligned perpendicularly to the laser polarization direction.

The anchoring energy decreases significantly at the N-I phase transition temperature and approaches zero. As heat is generated by the photoisomerization reaction induced by the incident laser light, the anchoring energy approaches zero, and in this state, a strong incident laser beam (optical tweezers) traps one topological charge of a disclination pair and moves it using optical tweezers. A planar soliton is generated along the movement path of the trapped topological charge.

By changing the intensity of the laser beam, the temperature of the laser spot can be precisely controlled to allow for easier trapping of one of the disclination pair.

According to the embodiment, a disclination pair can be generated by severing a π-wall existing in a liquid crystal using optical tweezers or by severing a predetermined point of a planar soliton generated due to movement of a topological charge with optical tweezers.

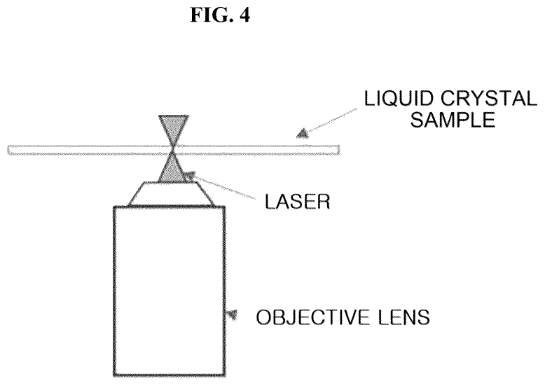

FIG. 4 is a diagram showing the configuration for trapping a topological charge using optical tweezers.

As shown in FIG. 4, one topological charge of a disclination pair of k=±½ can be trapped using an objective lens capable of strongly focusing light.

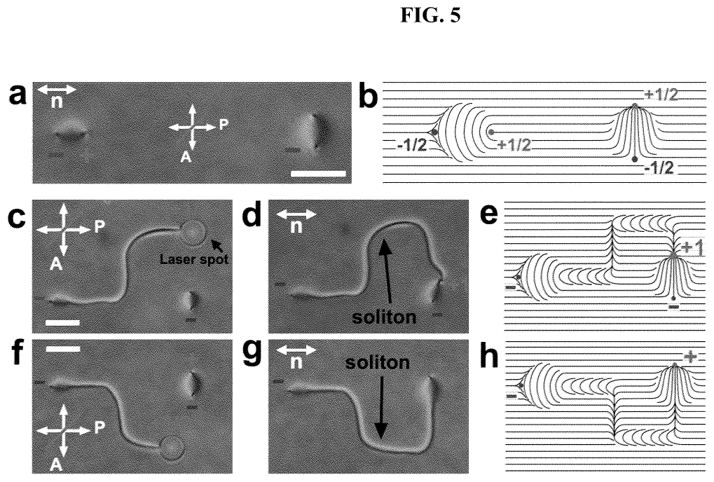

FIG. 5 shows a process of generating a planar soliton by trapping one topological charge of a disclination pair of k=±½.

In FIG. 5, a of FIG. 5 is a polarized light microscopic image showing two disclination pairs of k=±½ and b of FIG. 5 is a liquid crystal alignment diagram of the two disclination pairs.

C of FIG. 5 shows a process of trapping and moving a topological charge of k=±½ into another topological charge having the same topological charge value (k=±½). At this time, it can be seen that a planar soliton is generated along the moved path of the topological charge. D of FIG. 5 shows generation of a topological charge of k=±1 by combining the two topological charges and e of FIG. 5 is a liquid crystal alignment diagram of d of FIG. 5.

F of FIG. 5 shows a process of trapping and moving a topological charge of k=±½ into another topological charge having k=−½, and similarly, it can be seen that a planar soliton is generated in the movement path of the topological charge. G of FIG. 5 shows that two topological charges are combined and the topological charges are annihilated. H of FIG. 5 is a liquid crystal alignment diagram of g of FIG. 5. The same result can also be obtained by moving the topological charge of −½ of the right disclination pair, instead of moving the topological charge of +½ of the left disclination pair, along the same path as above and combining it with the topological charge of +½ of the left disclination pair. That is, when charges with opposite polarity are moved in opposite directions, a planar soliton with the same alignment structure is obtained, whereas when they are moved in the same direction, a planar soliton with a symmetric alignment structure is obtained. The scale bar shown in FIG. 5 represents 10 microns.

Referring to d of FIG. 5 and g of FIG. 5, a planar soliton may be generated by moving a topological charge. In addition, it is possible to see generation or annihilation of topological charges of k=±1 by combining the trapped topological charge with another topological charge, and it can be seen that the total topological charge value is conserved in this process. By combining a topological charge that generated a planar soliton with another topological charge using optical tweezers, it is possible to prevent the planar soliton from annihilating as the topological charge returns to its original position. If a topological charge is combined with another topological charge or positioned at a boundary where symmetry is broken, the planar soliton does not annihilate because the topological charge does not return to its original position even when it is not trapped by optical tweezers. However, when a topological charge is not trapped or fixed by optical tweezers, the topological charge returns to the original position to decrease the energy of the field and the planar soliton annihilates. Further, it is possible to make the middle of a planar soliton into an isotropic state using optical tweezers and sever the planar soliton by taking out the optical tweezers, and a new topological charge pair of k=±½ is generated at both ends of the severed planar soliton by the law of topological charge conservation, and when the topological charges are not trapped or fixed, they annihilate planar solitons while following the planar solitons, respectively. Accordingly, in order to remove the generated planar soliton, the trapped topological charge must either return along the path it traveled, i.e., the path where the planar soliton was created or use a method of severing a specific point of the planar soliton.

According to the embodiment, a single planar soliton is generated by trapping and relocating a specific topological charge using optical tweezers, so it is possible to generate a desired grating pattern as easily as drawing it.

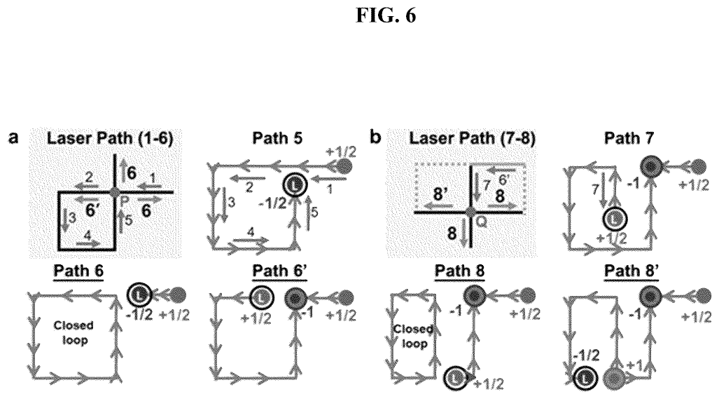

FIG. 6 is a diagram exemplarily showing a case in which disclinations of k=±1 or a closed-loop planar soliton is generated by reconnection (intercommutation; a process in which planar solitons switch counterparts upon crossing) of planar solitons according to the embodiment.

Referring to a of FIG. 6, when a topological charge of k=−½ is trapped by optical tweezers and moved from 1 to P5 and is then moved from the point P through the path 6′, a disclination of k=−1 is generated at the point P and the topological charge trapped by the optical tweezers is changed from k=−½ to k=±½ in accordance with topological charge conservation. When it is moved through the path 6, a closed loop planar soliton is formed, and the topological charge trapped by the optical tweezers is maintained at k=−½.

Referring to b of FIG. 6, when a disclination trapped after the path 6′ in a of FIG. 6 is moved from the point Q through the path δ′, a disclination of k=±1 is generated at the point Q and the topological charge trapped by the optical tweezers is changed from k=±½ to k=−½. That is, when it is moved from the path 1 to the path δ′ through the path 6′, topological charges of k=−1 and k=±1 are generated. This is due to the intercommutation of planar solitons and the law of topological charge conservation.

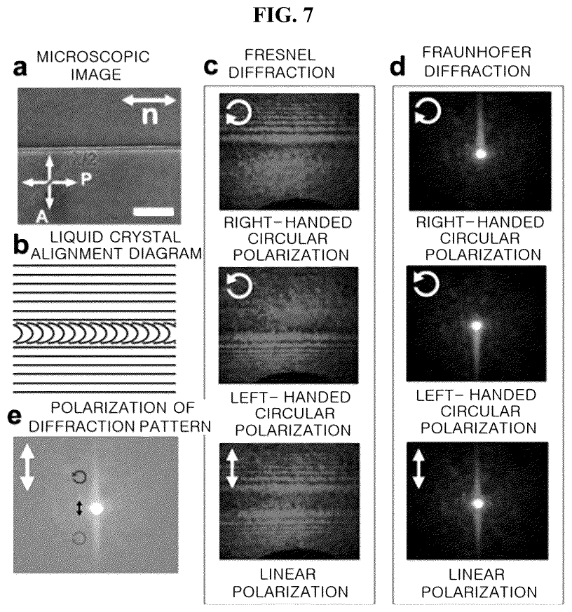

FIG. 7 shows optical characteristics of a single planar soliton according to the embodiment.

Referring to FIG. 7, it is possible to understand fundamentally how light diffracts and how its polarization changes through a planar soliton.

FIG. 7 shows a diffraction pattern made by a line of planar soliton, in which a of FIG. 7 is a polarized microscopic image of the generated planar soliton and b of FIG. 7 is a liquid crystal alignment diagram corresponding to it. The scale bar shown in a of FIG. 7 represents 30 microns.

C of FIG. 7 is a Fresnel diffraction (near-field diffraction) pattern observed depending on incident polarization passing through a planar soliton and d of FIG. 7 is images showing a Fraunhofer diffraction (far-field diffraction) pattern.

In c and d of FIG. 7, the arrows in the upper left corner of each image indicate incident polarization.

Incident light of right-handed or left-handed circular polarization is diffracted upward and downward, respectively, around a planar soliton. Further, incident light of linear polarization is diffracted in both directions, above and below a planar soliton.

Diffracted light has polarization orthogonal to incident circular polarization. That is, left-handed circular polarization changes to right-handed circular polarization, and right-handed circular polarization changes to left-handed circular polarization upon diffraction.

In more detail, when right-handed circular polarization is incident on a line of planar soliton, the polarization of the diffracted light is converted to left-handed circular polarization and is diffracted into a +th order, while a −th order diffracted light is not observed. Accordingly, when the incident light is left-handed circular polarization, the polarization of the diffracted light is converted to right-handed circular polarization and is diffracted into the −th order, while the +th order diffracted light is not observed.

In the Fraunhofer diffraction, which corresponds to far-field diffraction in d of FIG. 7, it can be observed that when incident light is right-handed circular polarization, the diffracted light changes to left-handed circular polarization and is diffracted in the upward direction (+th order), while when incident light is left-handed circular polarization, the diffracted light changes to right-handed circular polarization and is diffracted in the downward direction (−th order).

E of FIG. 7 is an image showing the Fraunhofer diffraction pattern when incident light is linear polarization. Since linear polarization is a combination of right-handed and left-handed circular polarizations, as shown in e of FIG. 7, the polarization of +th order diffracted light is left-handed circular polarization and the polarization of −th order diffracted light is right-handed circular polarization, with the 0-th order as the center. In this case, the polarization of the 0-th order light is not changed.

If it is a second planar soliton generated by moving a topological charge (e.g., +½ topological charge), which was moved when generating the planar soliton described above, in the direction opposite to the described direction, the liquid crystal alignment becomes symmetrical to that of the first planar soliton, so the diffraction direction becomes opposite to that of the first planar soliton.

That is, when incident light is right-handed circular polarization, the diffracted light of left-handed circular polarization is observed in the downward direction (−th order), and when incident light is left-handed circular polarization, the diffracted light with right-handed circular polarization is observed in the upward direction (+th order).

For example, if the planar soliton shown in FIG. 7 is generated along the movement path of a topological charge of k=±½, the resulting diffraction pattern and the diffraction pattern obtained by moving a topological charge of k=−½ along the same movement path may appear symmetrically to each other.

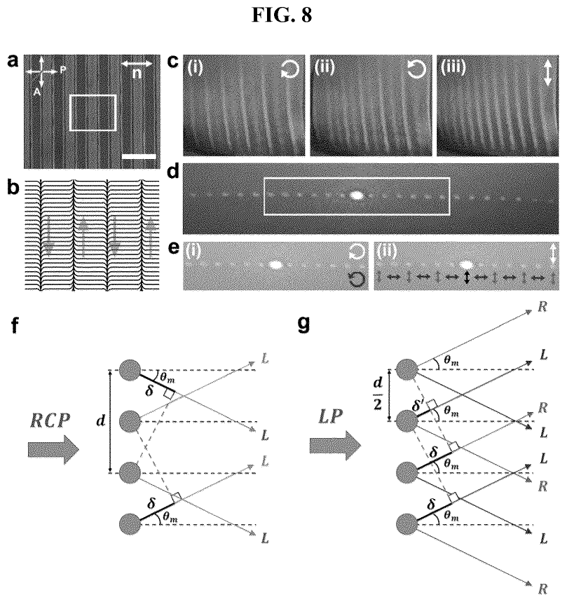

A of FIG. 8 is a microscopic image showing a symmetric planar soliton grating, which is generated by trapping a topological charge of k=±½ and moving it in an S-shape upward and downward (in the directions indicated by arrows in b of FIG. 8). B of FIG. 8 is a diagram showing the liquid crystal alignment in the box shown in a of FIG. 8. As shown in a and b of FIG. 8, it can be seen that the liquid crystal alignment of a planar soliton has a symmetric structure, depending on the movement direction of a topological charge. The Fresnel diffraction image and the Fraunhofer diffraction image of the planar soliton grating are shown in c of FIG. 8 and d of FIG. 8, respectively. (i), (ii), and (iii) of c of FIG. 8 show Fresnel diffraction patterns when the polarization of incident light is right-handed circular polarization, left-handed circular polarization, and linear polarization, respectively.

The scale bar shown in FIG. 8 represents 30 microns.

The symmetric structure of a planar soliton diffracts incident light having circular polarization in opposite directions centered on the planar soliton, and the diffraction direction changes depending on the incident circular polarization, as seen in (i) and (ii) of c of FIG. 8. When the polarization of incident light is linear polarization, both types of planar solitons with different liquid crystal alignments diffract incident light of right-handed circular polarization and left-handed circular polarization in both directions around the planar soliton, which can be seen in the Fresnel diffraction pattern of (iii) of c of FIG. 8.

D of FIG. 8 shows a Fraunhofer diffraction pattern and shows the same diffraction pattern regardless of the polarization of incident light. (i) and (ii) of e of FIG. 8 show the polarization of a diffraction pattern within the rectangular region of d of FIG. 8 when the polarization of incident light is right-handed circular polarization and linear polarization. As shown in d of FIG. 8, in Fraunhofer diffraction, which is far-field diffraction, both ±− order diffracted lights can be observed when incident light is circular polarization or linear polarization. This will be described with reference to f of FIG. 8. In this case, circles adjacent to each other represent two types of planar solitons with symmetric liquid crystal alignments, and it can be seen that when right-handed circular polarization is incident, all of them produce left-handed circularly polarized diffracted light, but the diffraction directions are opposite to each other, thereby forming ±orders, respectively ((i) of e of FIG. 8). When the diffracted lights passing through each planar soliton are interfered, constructive and destructive interferences occur, so the Fraunhofer diffraction pattern as shown in d of FIG. 8 is generated. When the polarization of incident light is circular polarization, the condition for the diffracted light passing through the planar soliton to undergo constructive interference at the m-th order (bright fringes) is that the path difference δ of the diffracted lights passing through each planar soliton must be an integer multiple of the wavelength of light, which is given by Equation 1.

$$δ = d sin ( {θ}_{m} ) = m λ \qquad [ Equation 1 ]$$

wherein, d is the gap between planar solitons with the same liquid crystal alignment, θₘ is the angle between the 0-th order and the m-th order constructive interference, and m represents the order of constructive interference of diffracted light, which has an integer value. λ represents the wavelength of incident light.

When the polarization of incident light is linear polarization, as shown in a of FIG. 8, each planar soliton diffracts it to right-handed circular polarization and left-handed circular polarization, and +th and −th diffracted lights make polarization interference of left-handed circular polarization and right-handed circular polarization. In this case, the path difference δ′ of the diffracted light of left-handed circular polarization passing through planar solitons adjacent to each other is a half of δ and is given by Equation 2.

$${δ}^{′} = \frac{d}{2} sin ( {θ}_{m} ) = \frac{m λ}{2} \qquad [ Equation 2 ]$$

When m is 1, the path difference δ′ of the left-handed circular polarization and right-handed circular polarization is a half wavelength, when m is 2, the path difference is one wavelength, and when m is 3, the path difference is 3/2 wavelength. Accordingly, when incident light is vertically linear polarization, left-handed circular polarization and right-handed circular polarization generate constructive interference at the same place, but the path difference δ′ between the two polarizations is

$$\frac{m λ}{2} ,$$

so, depending on the diffraction order m, the polarization has vertically linear polarization (m is even) or horizontally linear polarization (m is odd), which is shown in (ii) of e of FIG. 8.

If the gap between planar solitons adjacent to each other is d/2 or d/3, when incident light is linear polarization, the path difference δ′ between diffractive light of right-handed circular polarization passing through a first planar soliton and diffractive light of left-handed circular polarization passing through a second planar soliton adjacent to is as Equation 3. In this case, the phase difference between the left-handed circular polarization and right-handed circular polarization changes to 120°, 240°, 360°, etc., depending on the diffraction order, thereby having three different directions of linear polarization according to the diffraction order. In other words, when a planar soliton with a different liquid crystal alignment is arranged between planar solitons with the same liquid crystal alignment in a non-equidistant manner, the path difference between right-handed circular polarization and left-handed circular polarization passing through each planar soliton, as expressed in Equation 3, results in different directions of linear polarization depending on the diffraction order.

$${δ}^{′} = \frac{d}{3} sin ( {θ}_{m} ) = \frac{m λ}{3} \qquad [ Equation 3 ]$$

According to the embodiment, when the gap between planar solitons adjacent to each other is d/k (where, k is a positive rational number), diffracted light passing through the first planar soliton and diffracted light passing through the second planar soliton interfere, whereby they can represent linear polarization in which the polarization axis is rotated by 180°*m/k with respect to the polarization axis of the 0-th light, depending on the diffraction order.

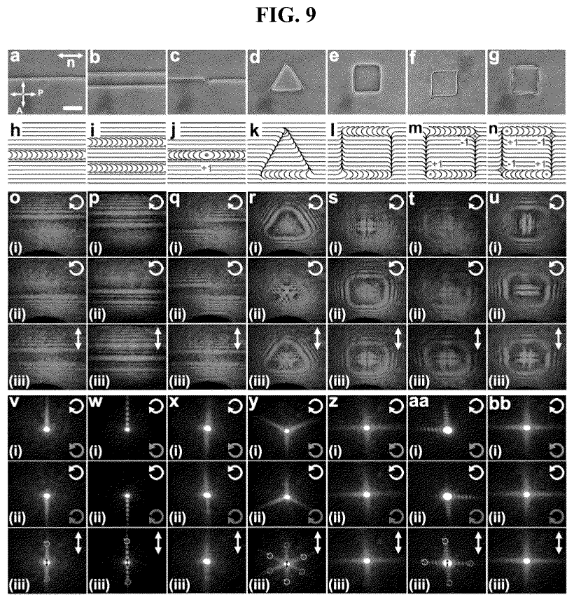

FIG. 9 shows the result of generating planar solitons through various methods in a nematic liquid crystal according to the embodiment and diffraction patterns in the cases.

A to g of FIG. 9 are polarized microscopic images of generated planar solitons with a half waveplate. The scale bar represents 30 microns.

H to n of FIG. 9 are liquid crystal alignment diagrams corresponding to each of the planar solitons of a to g of FIG. 9.

O to u of FIG. 9 show Fresnel diffraction (near-field diffraction) patterns according to the polarization of incident light passing through the planar solitons shown in a to g of FIG. 9, and v to bb of FIG. 9 are images showing Fraunhofer diffraction (far-field diffraction) patterns.

The arrows in the upper right corner of each image of Fresnel and Fraunhofer diffraction pattern images indicate incident polarization. When the incident light is right-handed circular polarization or left-handed circular polarization in the Fraunhofer diffraction pattern images, the polarization of diffracted light is indicated by a circular arrow at the lower right corner in each image. In v to bb of FIG. 9, (iii) show the case when the polarization of incident light is straight polarization, in which the polarization of diffracted light is shown in each image. The diffracted light of x and z of FIG. 9, and bb (iii) in which the polarization of the diffracted light is not shown has linear polarization and the polarization axis has a type that is periodically rotated in accordance with the position.

When there are planar solitons having two lines of alignment structure (i of FIG. 9), as shown in b of FIG. 9, diffracted lights from the two lines of planar solitons meet and interfere with each other. In the Fraunhofer diffraction pattern (w of FIG. 9), it is possible to see diffraction patterns of multiple orders due to interference.

When there is a topological charge of k=±1 generated through intercommutation at the middle of a planar soliton (c of FIG. 9), the liquid crystal alignment of the planar soliton (j of FIG. 9) has a symmetric shape with respect to the topological charge of k=±1, so it can be seen from the Fresnel diffraction pattern (q of FIG. 9) that the diffraction directions of incident circular polarization are opposite to each other in the planar soliton at the left part and the right part of the topological charge. Accordingly, it is possible to observe diffracted light in both of up and down directions (+ orders) with respect to 0-th light regardless of incident polarization in the Fraunhofer diffraction pattern (x of FIG. 9).

D to g of FIG. 9 show planar solitons of multiple closed loop types. D to e of FIG. 9 are closed-loop planar solitons without a topological charge and f and g of FIG. 9 are closed-loop planar solitons with one and two topological charge pairs of k=±1, respectively. When circular polarization is incident on the closed-loop planar solitons of d and e of FIG. 9, all the sides of the planar solitons diffract light inward or outward, depending on the polarization of the incident light ((i,ii) of r and s of FIG. 9). In e of FIG. 9, when the polarization of incident light is right-handed circular polarization, the left side and the right side of a closed-loop planar soliton diffract the incident light to the right and left sides, respectively, and the upper side and the lower side diffract the incident light up and down, respectively, so a Fresnel diffraction pattern is generated inside (s(i) of FIG. 9). When the incident polarization is linear polarization that is a combination of right-handed circular polarization or left-handed circular polarization, the incident light is diffracted from the soliton with the right-handed circular polarization inward and the left-handed circular polarization outward, so a Fresnel diffraction pattern is generated both inside and outside, as shown in s(iii) of FIG. 9. Accordingly, in the Fraunhofer diffraction pattern, diffraction patterns are always generated in four directions regardless of the polarization of incident light (z of FIG. 9).

When there is a topological charge pair of k=±1 in a closed-loop planar soliton, the diffraction directions of light are opposite to each other at the topological charges. Accordingly, in the case of f of FIG. 9, the left and right sides of the closed-loop planar soliton both diffract light in the same direction (left or right), and the upper and lower sides both also diffract light in the same direction (up or down). Accordingly, the diffractions shown in t of FIG. 9 and aa are shown.

In the case of a closed-loop planar soliton with topological charges of k=±1 and k=−1 at all of four corners, as in a and n of FIG. 9, when incident light is circular polarization, the upper and lower sides and the left and right sides diffract light in opposite directions, respectively, but, unlike e of FIG. 9, all the sides of the planar soliton do not diffract light inward or outward. That is, when incident light is right-handed circular polarization, the left and right sides of the closed-loop planar soliton diffract light inward, and the upper and lower sides diffract light outward (u (i) of FIG. 9). Accordingly, in the Fraunhofer diffraction pattern (bb of FIG. 9), it is possible to observe diffraction patterns in four directions regardless of the polarization of incident light, like the Fraunhofer diffraction pattern (z of FIG. 9) of e of FIG. 9.

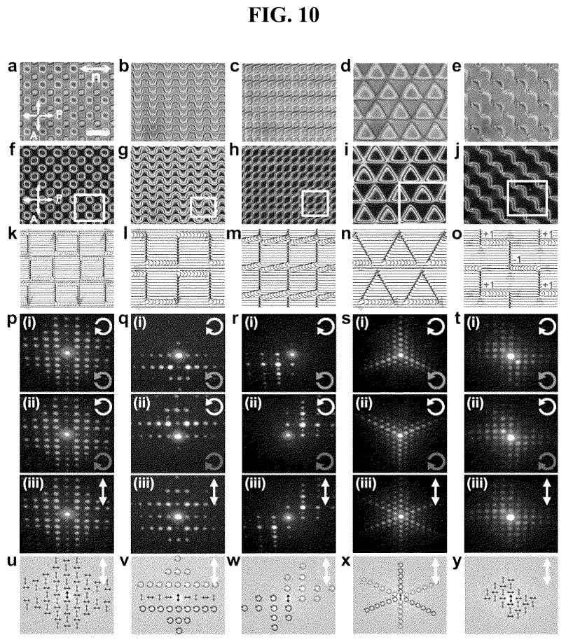

FIG. 10 shows the result of generating a planar soliton grating through various methods in a nematic liquid crystal according to the embodiment and diffraction patterns in the cases.

A to j of FIG. 10 are polarized microscopic images, in which a to e of FIG. 10 are polarized microscopic images with a half waveplate and f to j of FIG. 10 are polarized microscopic images without a half waveplate. The scale bar represents 30 microns in the figures.

K to o of FIG. 10 are liquid crystal alignment diagrams corresponding to the box parts in f to j of FIG. 10. In k to n of FIG. 10, arrows indicate movement paths of topological charges (based on k=±½) trapped by optical tweezers to generate a planar soliton grating. The liquid crystal alignment formed when a topological charge of k=±½ is moved in a first direction and the liquid crystal alignment of a topological charge of k=−½ when moving in the same direction as the first direction are symmetric, and accordingly, it is possible to obtain the same polarization grating by moving the trapped topological charge of k=−½ in the opposite direction of the arrow. In o of FIG. 10, the arrow indicates a movement path taken along a previously generated planar soliton by trapping one topological charge in the situation where the planar soliton grating of k of FIG. 10 is formed.

(i)˜(iii) of p to t of FIG. 10 show a Fraunhofer diffraction pattern when the polarization of incident light in a polarization grating is right-handed circular polarization (i), left-handed circular polarization (ii), and straight polarization (iii), respectively, in which the arrow at the upper right corner means incident polarization and the arrows at the lower right corner indicate the polarization of diffracted light. Further, it is also possible to observe the polarization of diffracted lights when the polarization of incident light is straight polarization from u of FIG. 10-y of FIG. 10. The microscopic image, alignment diagram, and diffraction and polarization patterns of each of diffraction gratings (a to e of FIG. 10) are given in the vertical direction in FIG. 10.

Referring to k of FIG. 10 to generate the diffraction grating shown in a of FIG. 10, topological charges of k=±½ are trapped with optical tweezers and moved in the direction of the predetermined arrow shown in k of FIG. 10 (moved in an S-shape in a large continuous stroke). Thereafter, a planar soliton grating is generated by moving the trapped charges (k=±½) in the direction of the opposite arrow (moving in an S-shape vertically in a large continuous stroke). As a result, it can be seen that the planar soliton grating generated through this process forms a 2D diffraction pattern regardless of the polarization of incident light when circularly polarized light is incident (p of FIG. 10). When linear polarization is incident on the planar soliton grating, the diffracted lights of left-handed circular polarization and right-handed circular polarization interfere, so that it is possible to observe the diffraction pattern composed of linear polarization, as shown in u of FIG. 10.

In order to generate the diffraction grating of b of FIG. 10, the arrow direction of i of FIG. 10 (movement direction of the topological charge of +½) is referred to. In the vertical direction, it is sufficient to continuously move the topological charge (k=±½) trapped with optical tweezers up and down through a continuous stroke, similar to k of FIG. 10. In the horizontal direction, it is sufficient to generate planar solitons having the same alignment. For this purpose, the topological charge having k=±½ is moved to the left from the right, and then, a topological charge of k=±1 is generated through intercommutation in the same way as FIG. 6. When a topological charge of k=±1 is generated, the topological charge that is trapped by optical tweezers changes from +½ to −½ in accordance with topological charge conservation, and when the topological charge of k=−½ changed in this way is moved to the right from the left on the next line, it is possible to obtain a planar soliton of the same shape as the previous line. Thereafter, when the topological charge of k=−1 is generated through intercommutation, the optical tweezers trap the topological charge of k=±½. When the topological charge changed in this way is moved to the left from the right on the next line, similarly, it is possible to obtain a planar soliton of the same shape as the previous one. When this process is repeated, it is possible to generate a planar soliton grating having the liquid crystal alignment shown in i of FIG. 10.

It was described above that a disclination of k=±1 is generated by moving a topological charge of k=±½ and then the changed topological charge of k=−½ is moved in the opposite direction of the movement direction of the topological charge of k=±½ indicated by a predetermined arrow, but the present invention is not limited thereto, and it is possible to generate a planar soliton having liquid crystal alignment shown in l of FIG. 10 even through a method of generating a disclination of k=−1 by moving the topological charge of k=−½ and then moving the changed topological charge of k=±½ in the opposite direction of the movement direction of the topological charge of k=−½. When light of circular polarization is incident on the generated planar soliton grating, all of planar solitons in the horizontal direction diffract the incident light in one same direction (up or down), but the planar solitons in the vertical direction alternately diffract the incident light to the left and right, respectively. Accordingly, it is possible to observe that the diffraction direction of light is changed up and down, depending on incident circular polarization, as shown in (i) and (ii) of q of FIG. 10. When incident light is straight polarization, the polarization of diffracted light has right-handed circular polarization and left-handed circular polarization at the upper portion and the lower portion, respectively (v of FIG. 10).

That is, a planar soliton grating according to the embodiment may be generated by continuously moving one topological charge, and may also be generated by moving a topological charge of another polarity or forming multiple disclination pairs and moving each topological charge.

In the case of c of FIG. 10, when circular polarization is incident on a planar soliton, the incident light is diffracted in the same direction (up or down) at all of the planar solitons in the horizontal direction and are also diffracted in the same direction (left or right) at all of the planar solitons in the vertical direction. Accordingly, as show in (i) and (ii) of r of FIG. 10, it is possible to observe that incident circular polarization is diffracted to left downward or right upward.

In the case of d of FIG. 10, it is a planar soliton grating generated by moving a topological charge in three different directions, as shown in n of FIG. 10. When light is incident on the planar soliton grating, each triangular planar soliton makes the diffraction pattern shown in y of FIG. 9 and they interfere with each other and become the diffraction pattern shown in s of FIG. 10.

The diffraction grating shown in e of FIG. 10 is formed by generating the planar soliton grating of a of FIG. 10 and then trapping and moving a topological charge of k=±½ or k=−½ in the arrow direction shown in o of FIG. 10. Disclinations of k=±1 are generated by removing planar solitons that have already generated on a movement path and simultaneously using intercommutation of planar solitons. As a result, a planar soliton grating with a disclination has the alignment shown in o of FIG. 10.

In the embodiment, a planar soliton is generated as the alignment of liquid crystal molecules on a movement path is changed while a disclination is moved by optical tweezers.

In addition, in the embodiment, it is possible to form a planar soliton on a liquid crystal cell in situ, thereby further increasing the degree of freedom in formation of a grating, as compared with the method of forming a polarization grating through interference or using a mask in the related art.

The above embodiments of the present invention are provided for examples, various modifications, changes, and additions may be possible within the spirit and scope of the present invention by those skilled in the art, and those modifications, changes, and additions should be construed as being included in the following claims.

What is claimed is:

1. A method of generating a polarization grating, the method comprising:
generating a disclination pair having topological charges of k=±½ and k=−½ in a liquid crystal;
trapping one first topological charge of the disclination pair using optical tweezers; and
generating a planar soliton by moving the trapped topological charge,
wherein desired diffracted light is obtained by the planar soliton.

2. The method of claim 1, wherein the generating of a disclination pair includes severing a π-wall existing in the liquid crystal using the optical tweezers or severing a predetermined point of the planar soliton using the optical tweezers.

3. The method of claim 1, wherein the generating of a disclination pair includes generating the disclination pair by optical-aligning a local area to be perpendicular to liquid crystal alignment using the optical tweezers and then generating a multi-domain of liquid crystal alignment due to spontaneous symmetry-breaking at a boundary between the optical-aligned area and the liquid crystal alignment through isotropic-nematic phase transition.

4. The method of claim 1, wherein the generating of a planar soliton includes generating a closed-loop planar soliton or a planar soliton grating with an irregular cycle or shape by continuously moving the trapped topological charge in an unlimited direction.

5. The method of claim 1, wherein when the first topological charge and a second topological charge with a different polarity are moved in opposite directions to each other, liquid crystal alignment has the same shape.

6. The method of claim 4, wherein the generating of a planar soliton grating includes:
moving the trapped first topological charge in a first direction;
generating a disclination having a topological charge of k=±1 or k=−1 using intercommutation of a planar soliton formed by movement of the first topological charge, wherein when the disclination having a topological charge of k=±1 or k=−1 is generated, the trapped first topological charge is changed to a second topological charge with a different polarity; and
generating a planar soliton grating by moving the second topological charge in a second direction different from the first direction.

7. The method of claim 6, wherein the generating of a planar soliton grating further includes repeatedly performing movement of the first topological charge in the first direction and movement of the second topological charge in the second direction.

8. The method of claim 1, wherein when right-handed circular polarization is incident on one line of the planar soliton, polarization of diffracted light is converted into left-handed circular polarization, and when incident light is left-handed circular polarization, polarization of diffracted light is converted into right-handed circular polarization.

9. The method of claim 1, wherein when straight polarization is incident on one line of the planar soliton, polarization of diffracted light becomes left-handed circular polarization and right-handed circular polarization at orders having different signs, respectively.

10. The method of claim 8, wherein polarization of diffracted light appearing at a + order and a − order is determined in accordance with liquid crystal alignment of the planar soliton.

11. The method of claim 4, wherein the planar soliton grating includes a plurality of first planar solitons having first liquid crystal alignment and spaced at predetermined gap, and a second planar soliton having liquid crystal alignment different from the first liquid crystal alignment and disposed between the plurality of first planar solitons.

12. The method of claim 11, wherein when polarization of incident light is circular polarization, constructive interference of diffracted lights passing through a plurality of first planar solitons spaced by d from each other is defined as a case in which a first path difference of the diffracted lights is an integer multiple of a wavelength of light.

13. The method of claim 12, wherein when polarization of incident light is linear polarization and a gap between the plurality of first planar solitons and the second planar soliton is d/2, a second path difference of diffracted light passing through the first planar solitons and diffracted light passing through the second planar soliton is defined as a half of the first path difference.

14. The method of claim 13, wherein when a gap between one of the plurality of first planar solitons and the second planar soliton is d/k (where, k is a positive rational number), diffracted light passing through the first planar solitons and diffracted light passing through the second planar soliton interfere with each other, so linear polarization in which an polarization axis is rotated by 180°*m/k with respect to a polarization axis of 0-th light in accordance with a diffraction order m.

15. The method of claim 4, wherein the planar soliton grating includes a plurality of planar solitons having different liquid crystal alignment or a plurality of closed-loop planar solitons having one or more polygonal shapes.

16. A polarization grating generated by the method of claim 1.

17. The method of claim 9, wherein polarization of diffracted light appearing at a + order and a − order is determined in accordance with liquid crystal alignment of the planar soliton.
